(19) United States
(12) Patent Application Publication
(10) Pub. No.: US 2008/0249770 A1
(43) Pub. Date: Oct. 9, 2008

(54) Method and apparatus for searching for music based on speech recognition

(75) Inventors: Kyu-hong Kim, Yongin-si (KR); Jeong-su Kim, Yongin-si (KR); Ick-sang Han, Yongin-si (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRONICS CO., LTD., Suwon-si (KR)

(21) Appl. No.: 11/892,137

(22) Filed: Aug. 20, 2007

(30) Foreign Application Priority Data
Jan. 26, 2007 (KR) 10-2007-0008583

(51) Int. Cl. G10L 15/00

(52) U.S. Cl. 704/231; 704/E15.001

(57) ABSTRACT

Provided is a method and apparatus for searching music based on speech recognition. By calculating search scores with respect to a speech input using an acoustic model, calculating preferences in music using a user preference model, reflecting the preferences in the search scores, and extracting a music list according to the search scores in which the preferences are reflected, a personal expression of a search result using speech recognition can be achieved, and an error or imperfection of a speech recognition result can be compensated for.

### CROSS-REFERENCE TO RELATED PATENT APPLICATION

This application claims the benefit of Korean Patent Application No. 10-2007-0008583, filed on Jan. 26, 2007, in the Korean Intellectual Property Office, the disclosure of which is incorporated herein in its entirety by reference.

### BACKGROUND OF THE INVENTION

1. Field of the Invention

The present invention relates to a speech recognition method and apparatus, and more particularly, to a method and apparatus for searching music based on speech recognition.

2. Description of the Related Art

Recently, while music players, such as MP3 players, cellular phones, and Personal Digital Assistants (PDAs), have been miniaturized, vast memory for storing music has become available, and in terms of design, the number of buttons has been reduced and user interfaces have become simpler. Due to a decrease in memory price and the miniaturization of parts, the amount of music that it is possible to store has increased, and the need to perform an easy music search has increased.

Two methods can be basically considered for the easy music search. That is, a first one is a method of searching music using buttons, and a second one is a method of searching music using speech recognition.

According to the first method, the music search is convenient as the number of buttons increases, but design may be affected. Furthermore, when a large amount of music is stored, the number of button pushes increases, and it is inconvenient to search music.

According to the second method, even if a large amount of music is stored, it is easy to search music, and design is not affected. However, there is a limitation in that the speech recognition performance is not perfect.

However, accompanying the improvement of speech recognition technology, the possibility that speech recognition is employed as a search tool in small mobile devices is increasing, and many products based on speech recognition have become available on the market. In addition, many studies related to custom-made devices have been performed, and one of them is related to searching a user's desired music.

FIG. 1 is a block diagram of an apparatus for searching music based on speech recognition according to the prior art.

Referring to FIG. 1, the apparatus includes a feature extractor 100, a search unit 110, an acoustic model 120, a lexicon model 130, a language model 140, and a music database (DB) 150.

When music is searched using speech recognition, for all music in which a keyword input by a user, e.g. [symbol] exists in a music title, the same score is generated, and the user's undesired music is evenly distributed in a search result list. In addition, there exists the possibility that desired music is located in a lower rank due to false recognition.

For example, when a user who likes ballads searches music by speaking [symbol] in order to search a ballad song [symbol] [symbol] a result as illustrated in Table 1 is obtained.

TABLE 1

| Song title | Log likelihood |
|---|---|
| [symbol] [symbol] | −9732 |
| [symbol] | −9732 |
| [symbol] | −9732 |
| [symbol] | −9732 |
| [symbol] [symbol] | −9732 |
| [symbol] | −9747 |
| . . . | . . . |

Although the desired song has a high search score, its rank is fifth and a rank of an undesired song is higher.

### SUMMARY OF THE INVENTION

The present invention provides a method and apparatus for searching music based on speech recognition and music preference of a user.

According to an aspect of the present invention, there is provided a method of searching music based on speech recognition, the method comprising: calculating search scores with respect to a speech input using an acoustic model; calculating preferences in music using a user preference model and reflecting the preferences in the search scores; and extracting a music list according to the search scores in which the preferences are reflected.

According to another aspect of the present invention, there is provided an apparatus for searching music based on speech recognition, the apparatus comprising: a user preference model modeling and storing a user's favored music; and a search unit calculating search scores with respect to speech input using an acoustic model, calculating preferences in music using the user preference model, and extracting a music list by reflecting the preferences in the search scores.

According to another aspect of the present invention, there is provided an apparatus for searching music based on speech recognition, which comprises a feature extractor, a search unit, an acoustic model, a lexicon model, a language model, and a music database (DB), the apparatus comprising a user preference model modeling a user's favored music, wherein the search unit calculates search scores with respect to a speech feature vector input from the feature extractor using the acoustic model, calculates preferences in music stored in the music DB using the user preference model, and extracts a music list matching the input speech by reflecting the preferences in the search scores.

According to another aspect of the present invention, there is provided a computer readable recording medium storing a computer readable program for executing the method.

### BRIEF DESCRIPTION OF THE DRAWINGS

The above and other features and advantages of the present invention will become more apparent by describing in detail exemplary embodiments thereof with reference to the attached drawings in which:

FIG. 1 is a block diagram of an apparatus for searching music based on speech recognition according to the prior art;

FIG. 2 is a block diagram of an apparatus for searching music based on speech recognition according to an embodiment of the present invention;

FIG. 3 is a block diagram of a search unit illustrated in FIG. 2;

FIG. 4 is a block diagram of an apparatus for searching music based on speech recognition according to another embodiment of the present invention;

FIG. 5 is a block diagram of a search unit illustrated in FIG. 4;

FIG. 6 is a flowchart of a method of searching music based on speech recognition according to an embodiment of the present invention; and

FIGS. 7 through 10 are music file lists for describing an effect obtained by a method and apparatus for searching music based on speech recognition according to an embodiment of the present invention.

### DETAILED DESCRIPTION OF THE INVENTION

The present invention will be described in detail by explaining preferred embodiments of the invention with reference to the attached drawings.

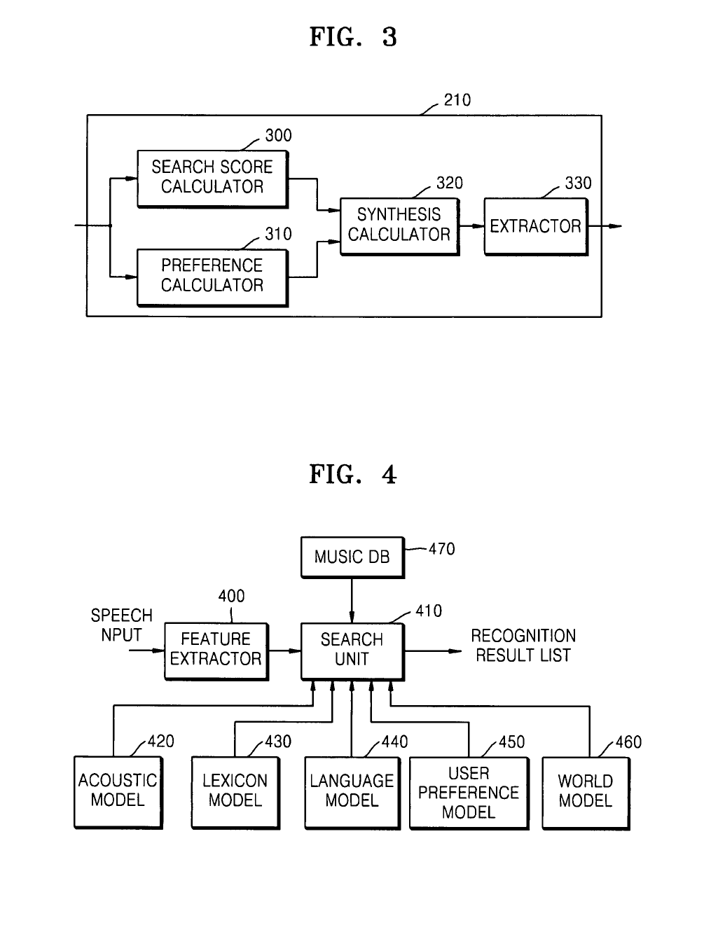

FIG. 2 is a block diagram of an apparatus for searching music based on speech recognition according to an embodiment of the present invention.

Referring to FIG. 2, the apparatus includes a feature extractor 200, a search unit 210, an acoustic model 220, a lexicon model 230, a language model 240, a user preference model 250, and a music database (DB) 260.

The feature extractor 200 extracts a feature of a digitally-converted speech signal that is generated by a converter (not shown) converting an analog speech signal into a digital speech signal.

In general, a speech recognition device receives a speech signal and outputs a recognition result, wherein a feature for identifying each recognition element in the speech recognition device is a feature vector, and the entire speech signal may be used as a feature vector. However, since a speech signal generally contains too much unnecessary information to be used for speech recognition, only components determined to be necessary for the speech recognition are extracted as a feature vector.

The feature extractor 200 receives a speech signal and extracts a feature vector from the speech signal, wherein the feature vector is obtained by compressing only components necessary for speech recognition from the speech signal and the feature vector commonly has temporal frequency information.

The feature extractor 200 can perform various pre-processing processes, e.g. frame unit configuration, Hamming window, Fourier transformation, filter bank, and cepstrum conversion processes, in order to extract a feature vector from a speech signal, and the pre-processing processes will not be described in detail since they would obscure the invention in unnecessary detail.

The acoustic model 220 indicates a pattern by which the speech signal can be expressed. An acoustic model generally used is based on a Hidden Markov Model (HMM). A basic unit of an acoustic model is a phoneme or pseudo-phoneme unit, and each model indicates a single acoustic model unit and generally has three states.

Units of the acoustic model 220 are a monophone, diphone, triphone, quinphone, syllable, and word. A monophone is dealt with by considering a single phoneme, a diphone is dealt with by considering a relationship between a phoneme and a different previous or subsequent phoneme, a triphone is dealt with by considering both previous or subsequent phonemes.

The lexicon model 230 models the pronunciation of a word, which is a recognition unit. The lexicon model 230 includes a model having one pronunciation per word using representative pronunciation obtained from a standard lexicon dictionary, a multi-pronunciation model using several entry words in a recognition vocabulary dictionary in order to consider allowed pronunciation/dialect/accent, and a statistical pronunciation model considering a probability of each pronunciation.

The language model 240 stores grammar used by the speech recognition device, and includes grammar for a formal language or statistical grammar including n-gram.

The user preference model 250 models and stores types of a user's favored or preferred music. The user preference model 250 can be implemented with memory by means of hardware and modeled by using various modeling algorithms.

The music DB 260 stores a plurality of music files and is placed in a music player. Music data stored in the music DB 260 may include a feature vector normalized according to an embodiment of the present invention in a header of a music file.

The search unit 210 searches music that matches input speech from music files stored in the music DB 260 by calculating search scores with respect to the input speech. Vocabularies to be recognized are extracted from file names or metadata of the music files stored in the music DB 260, and speech recognition search scores of the extracted vocabularies corresponding to the speech input by the user are calculated using the acoustic model 220, the lexicon model 230, and the language model 240.

In addition, the search unit 210 calculates user preferences of the music files stored in the music DB 260 using the user preference model 250 and extracts music files in the order of highest to lowest speech recognition search scores in which the user preferences are reflected by combining the speech recognition search scores with respect to the input speech and the user preferences.

As illustrated in FIG. 2, when music is searched based on speech recognition by using a user's music preferences with speech recognition, the user's desired music can be in a higher rank.

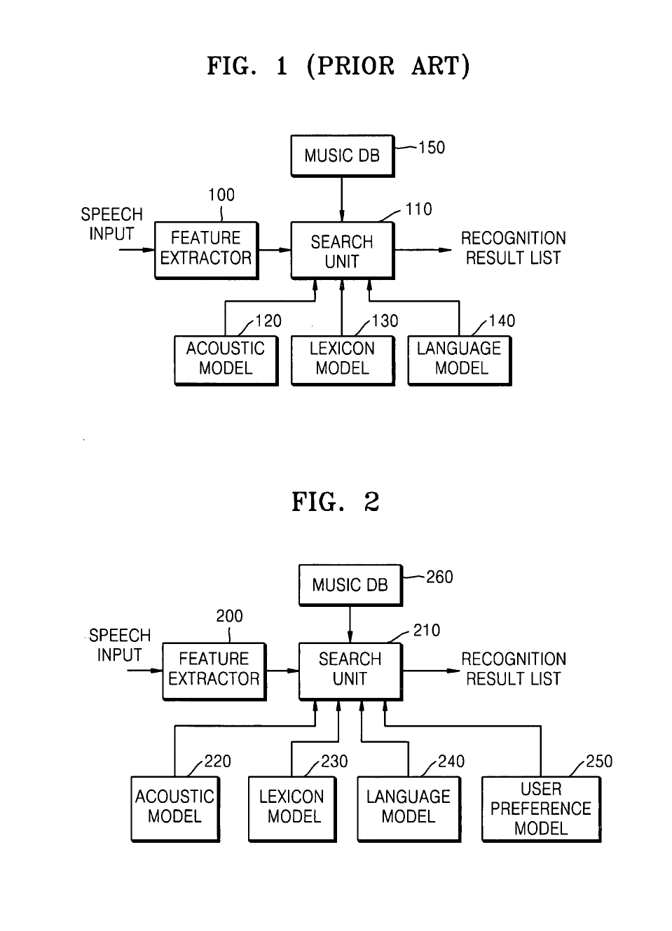

Compared to the apparatus for searching music based on speech recognition, which is illustrated in FIG. 1, by adding the user preference model 250 when music is searched based on speech recognition, scores according to user preferences are reflected in search scores based on speech recognition, resulting in a more preferable search result.

Table 2 is an example for comparison with Table 1, and a search result using the apparatus for searching music based on speech recognition according to an embodiment of the present invention is changed in the order of user favored music. That is, even if song titles have the same word, different search scores are shown in Table 2.

TABLE 2

| Song title | Preference based score |
|---|---|
| [symbol] [symbol] | −12522 |
| [symbol] 2 | −12524 |
| [symbol] | −12525 |
| [symbol] | −12527 |
| [symbol] | −12533 |
| . . . | . . . |

The search result of Table 2 shows that the user's desired music [symbol] [symbol] has the highest score.

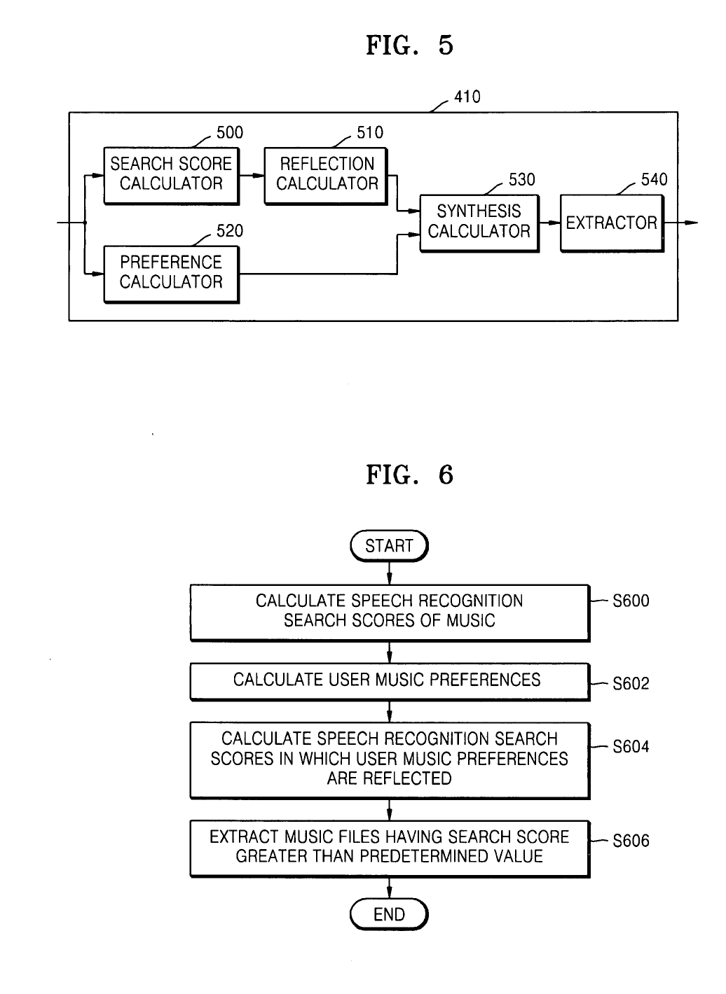

A configuration of the search unit 210 used to calculate search scores using models will now be described with reference to FIG. 3.

FIG. 3 is a block diagram of the search unit 210 illustrated in FIG. 2.

Referring to FIG. 3, the search unit 210 includes a search score calculator 300, a preference calculator 310, a synthesis calculator 320, and an extractor 330.

The search score calculator 300 calculates search scores with respect to input speech. That is, the search score calculator 300 determines grades that match the input speech for all vocabularies to be recognized, e.g. all music files stored in a mobile device.

In general, the speech recognition device searches a word model closest to a speech input x. A speech recognition score calculated for every word W is represented by a posterior probability as given by Equation 1.

Score(W)=P(λ_{w}|x) (1)

If Equation 1 is expanded according to Bayes rule, Equation 2 is obtained.

$$P ( {λ}_{w} \vert x ) = \frac{P ( x \vert {λ}_{w} ) P ( W )}{P ( x )} \qquad ( 2 )$$

When a search or speech recognition is performed using Equation 2, since P(x) has the same value for all words, P(x) is ignored in general, and since it is assumed that a word probability P(W) is constant in a general isolated word recognition system, Equation 2 consists of only acoustic likelihood as represented by Equation 3.

Score(W)=P(x|λ_{w}) (3)

By applying Equation 3 to a partial vocabulary search, music files are searched based on speech recognition as follows.

It is assumed that text information corresponding to a music file name or metadata of a music file to be searched is W. For example, for a music file [symbol] [symbol] mp3”, W is a character stream [symbol] [symbol] mp3”, and words corresponding to a partial name w are [symbol] [symbol] [symbol] [symbol] [symbol] [symbol] and the like.

If it is assumed that x is a feature vector sequence with respect to a speech input, a speech search score of the music file W is represented by Equation 4.

$$Score ( W ) = {max}_{w ∈ W} \{ log P ( x \vert {λ}_{w} ) \} \qquad ( 4 )$$

Here, λ_{w} denotes an acoustic model of partial name words w. Music search is achieved by calculating the search score represented by Equation 4 for all registered music files.

The preference calculator 310 calculates a user preference with respect to a music title W.

If it is defined that a user music preference is P(W|U), the user music preference P(W|U) can be calculated by a likelihood of a preference/non-preference model as given by Equation 5.

$$P ( W \vert U ) = \frac{P ( W \vert {U}^{+} )}{P ( W \vert {U}^{-} )} \qquad ( 5 )$$

Here, U⁺ denotes a positive user preference model, and U⁻ denotes a negative user preference model.

For a user preference model, a genre feature set must be determined, and only if a feature set {f1, f2, through to fM} is extracted from music data of the music title W, can a user preference be modeled, and a preference grade be calculated.

It is defined that a value obtained by taking the logarithm of Equation 5 is a user preference pref(W) as represented by Equation 6.

$$log \{ P ( W \vert U ) \} = log \{ \frac{P ( W \vert {U}^{+} )}{P ( W \vert {U}^{-} )} \} = pref ( W ) \qquad ( 6 )$$

If it is assumed that a feature vector is an uncorrelated Gaussian random variable, the user preference of the music title W is calculated from a weighted sum of preferences with respect to a feature vector as represented by Equation 7, wherein feature weighting coefficients have the condition represented by Equation 8.

$$\begin{matrix}pref ( W ) = {\sum }_{k = 1}^{M} {w}_{k} \cdot pref ( {f}_{k} ) & ( 7 ) \\ {\sum }_{k = 1}^{M} {w}_{k} = 1 & ( 8 )\end{matrix}$$

Thus, a preference for each feature can be calculated by using Equation 9.

$$pref ( {f}_{k} ) = log \frac{P ( {f}_{k} \vert {U}^{+} )}{P ( {f}_{k} \vert {U}^{-} )} = log \frac{ \frac{1}{\sqrt{2 {πσ}_{k , {u}^{+}}^{2}}} exp \{ - \frac{{( {f}_{k} - {μ}_{k , {u}^{+}} )}^{2}}{2 {σ}_{k , {u}^{+}}^{2}} \}}{\frac{1}{\sqrt{2 {πσ}_{k , {u}^{-}}^{2}}} exp \{ - \frac{{( {f}_{k} - {μ}_{k , {u}^{-}} )}^{2}}{2 {σ}_{k , {u}^{-}}^{2}} \}} \qquad ( 9 )$$

That is, a user preference of a music file is defined by Equation 6, and calculated by substituting Equations 7 and 9 into Equation 6.

A model parameter set needed to calculate a user preference is represented by Equation 10.

λᵤ={μ_{k,u}+,σ²_{k,u},nᵤ,μ_{k,u}−,σ²_{k,u}−,nᵤ−} (10)

Here, the model parameter set is divided into the positive user preference model and the negative user preference model, and contains the number of accumulated update counts nᵤ for updating the positive user preference model and negative user preference model. An initial value of a user preference model may be pre-calculated using a music DB.

A feature vector of music titles are extracted from a music DB and calculated, and a mean value and a variance value of features are respectively calculated by using Equations 11 and 12.

$$\begin{matrix}{μ}_{k} = \frac{1}{N} {\sum }_{k = 1}^{N} {f}_{k} & ( 11 ) \\ {σ}_{k}^{2} = \frac{1}{N} {\sum }_{k = 1}^{N} {( {f}_{k} - {μ}_{k} )}^{2} & ( 12 )\end{matrix}$$

Here, N is the number of music files registered in the music DB, and k is a feature degree.

More details for calculating user preference scores of music files using a user preference model are disclosed in Korean Patent Application No. 2006-121792 by the present applicant.

The synthesis calculator 320 calculates search scores in which user preferences are reflected by combining the speech recognition search scores calculated by the search score calculator 300 and the preferences calculated by the preference calculator 310.

That is, for a speech input, a search score of each music file is calculated by adding the user music preference model U.

A search score in which a preference is reflected is represented by Equation 13.

$$Score ( W ) = \frac{{max}_{w ∈ W} \{ log P ( x \vert {λ}_{w} ) \}}{{N}_{frame}} + {α}_{user} \cdot log P ( W \vert U ) \qquad ( 13 )$$

Here, N_{frame} denotes the length of an input speech feature vector, and αᵤₛₑᵣ denotes a constant indicating how much a music preference is reflected.

In Equation 13, the left item

$$( \frac{{max}_{w ∈ W} \{ log P ( x \vert {λ}_{w} ) \}}{{N}_{frame}} )$$

is normalized by the number of frames in order to prevent a value from varying according to a speech input length.

According to Equation 13, each search score is calculated by linearly combining a speech recognition score and a user preference.

The extractor 330 searches music files having a search score in which a preference is reflected greater than a predetermined value and outputs a recognition result list.

By calculating Equation 13 for all registered music files and searching music files having a calculation value greater than the predetermined value, a music search result, based on speech recognition in which a user preference is reflected, is obtained.

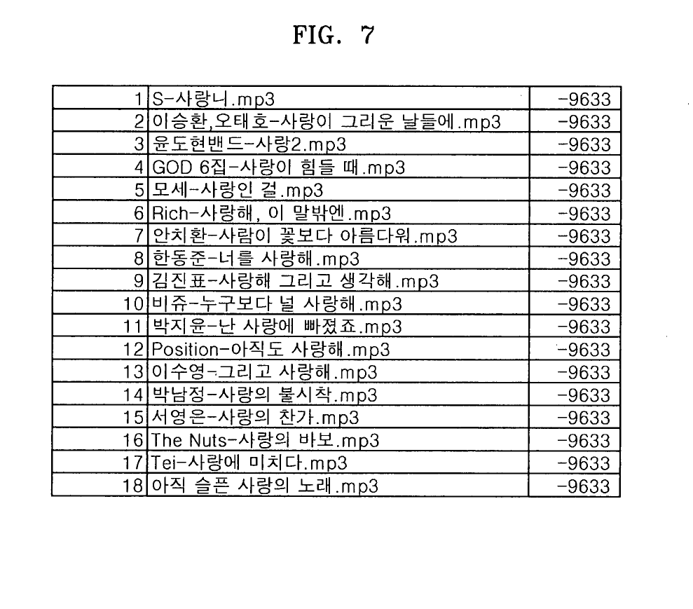

FIG. 4 is a block diagram of an apparatus for searching music based on speech recognition according to another embodiment of the present invention.

Referring to FIG. 4, the apparatus includes a feature extractor 400, a search unit 410, an acoustic model 420, a lexicon model 430, a language model 440, a user preference model 450, a world model 460, and a music DB 470.

Compared to the configuration illustrated in FIG. 2, the only difference is that the world model 460 is added to the configuration illustrated in FIG. 4. Since a dynamic range of an acoustic likelihood of input speech varies according to a change in environment of the input speech, the world model 460 is added to reflect the variation of the dynamic range.

In particular, in a mobile device having the possibility that various noise signals can be mixed with input speech, a user preference cannot be reflected with a constant ratio, and thus the world model 460 is used to allow an acoustic search score to always have a constant dynamic range even if a speaking environment changes.

In general, according to the principle of speech recognition, when a word model is given, speech recognition is performed to search for a word model that most satisfies a posterior probability of input speech x, and can be represented by Equation 14.

$$\hat{w} = arg {max}_{all w} P ( w \vert x ) \qquad ( 14 )$$

Bayes rule is applied to Equation 14, and since the word model P(w) is in general a constant having a uniform distribution in isolated word recognition, the basis of speech recognition is represented by Equation 15.

$$\hat{w} = arg {max}_{all w} \frac{P ( x \vert w )}{p ( x )} \qquad ( 15 )$$

In the speech recognition, since p(x) is independent of w, p(x) is generally ignored. A value of p(x) indicates the speech quality of input speech.

In an embodiment of the present invention, since a speech recognition search score must be combined with a user preference score, in order to normalize a dynamic range regardless of a change of an acoustic likelihood due to the addition of noise to input speech, p(x) ignored in the speech recognition is approximated. p(x) is represented by a weighted sum of all acoustic models according to the rule represented by Equation 16.

$$p ( x ) = {\sum }_{all m} p ( x \vert m ) p ( m ) \qquad ( 16 )$$

Since it is impossible to correctly calculate p(x) using Equation 16, p(x) is approximated using a Gaussian Mixture Model (GMM). The GMM constructs a model with an Expectation-Maximization (EM) algorithm using data used when an acoustic model was generated. The GMM is defined as the world model 460.

Thus, Equation 16 is approximated to Equation 17.

$$\begin{matrix}p ( x ) = {\sum }_{all m} p ( x \vert m ) p ( m ) \\ ≅ {\prod }_{frame t} {\sum }_{k = 1}^{M} {m}_{k} \cdot N ( {x}_{t} , μ , {σ}^{2} ) = P ( x \vert {λ}_{world} )\end{matrix} \qquad ( 17 )$$

Here, mₖ denotes a k^{th} mixture weight in the GMM.

According to an embodiment of the present invention, a search score is calculated by additionally using the world model 460 as illustrated in FIG. 4.

A speech recognition search score in which a preference is reflected is represented by Equation 18.

$$Score ( W ) = \frac{{max}_{w ∈ W} \{ log P ( x \vert {λ}_{w} ) \} - log P ( x \vert {λ}_{world} )}{{N}_{frame}} + {α}_{user} \cdot log P ( W \vert U ) \qquad ( 18 )$$

Here, λ_{world} denotes the world model 460 used to remove an affection due to a change in speaking environment. As described above, the world model 460 is added to keep the affection due to the change in environment constant when a likelihood of an acoustic model is reflected in the entire scores.

In Equation 18, the left item

$$( \frac{{max}_{w ∈ W} \{ log P ( x \vert {λ}_{w} ) \} - log P ( x \vert {λ}_{world} )}{{N}_{frame}} )$$

is normalized by the frame length in order to constantly reflect input speech in a search score regardless of a speaking length by normalizing an acoustic model score with the speaking length.

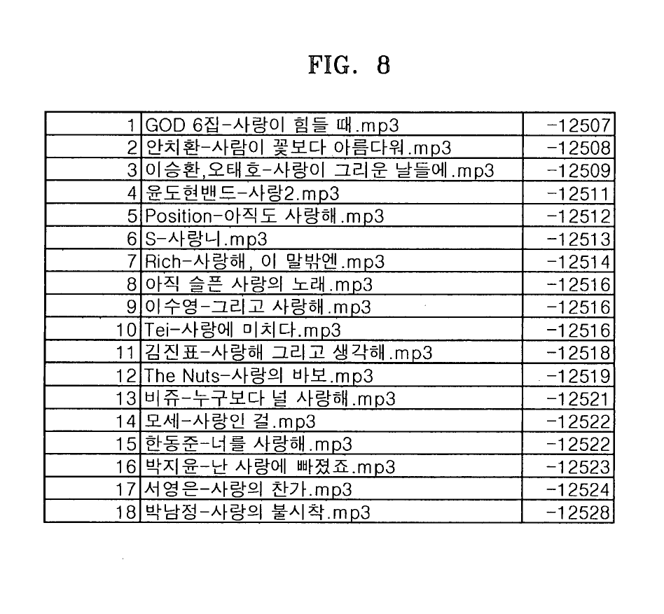

FIG. 5 is a block diagram of the search unit 410 illustrated in FIG. 4.

Referring to FIG. 5, the search unit 410 includes a search score calculator 500, a reflection calculator 510, a preference calculator 520, a synthesis calculator 530 and an extractor 540.

Compared to the configuration of the search unit 210 illustrated in FIG. 3, the reflection calculator 510 is added. The reflection calculator 510 calculates a reflection grade by approximating p(x) ignored in the speech recognition in order to normalize a dynamic range regardless of a change of an acoustic likelihood due to the addition of noise to input speech.

The reflection calculator 510 calculates a reflection grade of p(x) using the world model 460 according to Equation 17, and the synthesis calculator 530 calculates a search score in which a preference is reflected according to Equation 18.

Selectively, the reflection calculator 510 may calculate p(x) according to Equation 19, in order that an acoustic search score is not affected by a change in speaking environment, by using the acoustic model 420 used in speech recognition.

$$\begin{matrix}p ( x ) = {\sum }_{all m} p ( x \vert m ) p ( m ) \\ ≅ {\prod }_{all frame t} \frac{{\sum }_{phone p} P ( {x}_{t} \vert {λ}_{p} )}{{N}_{p}} = P ( x \vert {λ}_{phone} )\end{matrix} \qquad ( 19 )$$

Here, Nₚ denotes the number of monophones. When p(x) is calculated using Equation 19, if all registered tied state triphone unit models are calculated, a large amount of additional computation must be performed, and thus, the speech recognition device calculates only monophones. In this case, the maximum value of all state likelihoods constructing monophones is selected.

If only tied state triphones exist in the acoustic model 420, when a speech recognition score is calculated, the maximum value of triphone likelihoods having the same centerphone is defined as a monophone likelihood. In addition, if a calculation-omitted portion exists in a Viterbi search, this value is replaced by a pre-defined constant value or the minimum value of likelihoods of searched monophones.

The synthesis calculator 530 uses Equation 20 in order to calculate a search score in which a preference is reflected.

$$Score ( W ) = \frac{{max}_{w ∈ W} \{ log P ( x \vert {λ}_{w} ) \} - log P ( x \vert {λ}_{phone} )}{{N}_{frame}} + {α}_{user} \cdot log P ( W \vert U ) \qquad ( 20 )$$

This has an advantage in that no additional memory or computation is needed since a value calculated inside the speech recognition device, i.e. the acoustic model 420, is used.

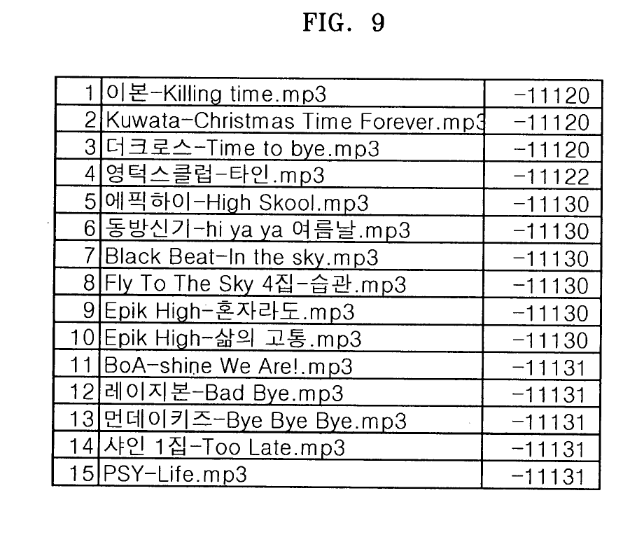

FIG. 6 is a flowchart of a method of searching music based on speech recognition according to an embodiment of the present invention.

Referring to FIG. 6, an apparatus for searching music based on speech recognition calculates speech recognition search scores of music in operation S600. The search scores can be calculated using Equations 1 through 4.

Selectively, the search scores can be calculated by considering a speaking environment of a user.

User preferences of the music are calculated in operation S602. The user preferences can be calculated using Equations 5 through 12. According to embodiments of the present invention, although it is described that speech recognition search scores are calculated and then user preferences are calculated, the speech recognition search scores and the user preferences can be calculated at the same time, or the user preferences can be calculated prior to the calculation of the speech recognition search scores.

Speech recognition search scores, in which the user preferences are reflected, are calculated in operation S604 by reflecting the user preferences calculated in operation S602 in the speech recognition search scores calculated in operation S600. The speech recognition search scores in which the user preferences are reflected can be calculated using Equation 13, 18, or 20.

Music files having a search score calculated in operation 604 greater than a predetermined value are extracted in operation S606.

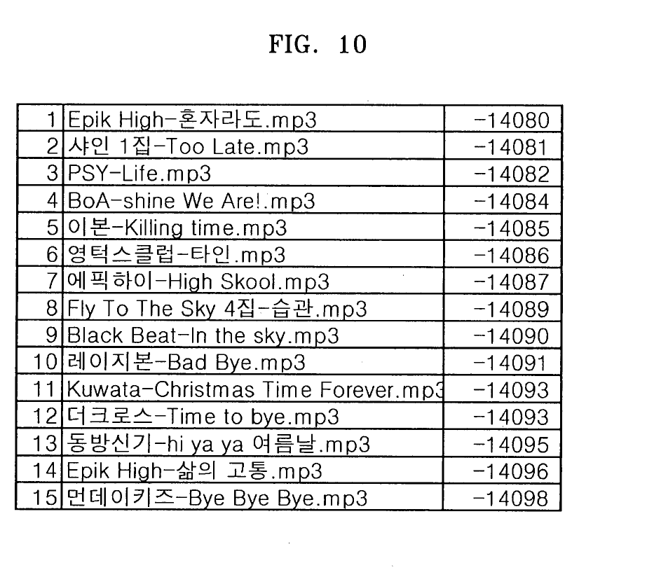

FIGS. 7 through 10 are music file lists for describing an effect obtained by a method and apparatus for searching music based on speech recognition according to an embodiment of the present invention.

FIG. 7 shows a partial object name recognition result and search scores when [symbol] is spoken as input speech using a conventional apparatus for searching music based on speech recognition.

FIG. 8 shows a result obtained by reflecting a user preference when [symbol] is spoken as input speech using a method and apparatus for searching music based on speech recognition according to an embodiment of the present invention. Referring to FIG. 8, a user's favored music files have higher ranks, resulting in a change in search scores.

FIG. 9 shows a speech search result obtained when [symbol] is input in a noisy environment using a conventional apparatus for searching music based on speech recognition. In a search list, correct search results are enlisted in eleventh and fourteenth ranks. This shows a problem of speech recognition technology in a noisy environment.

FIG. 10 shows a result obtained when [symbol] is input in a noisy environment using a method and apparatus for searching music based on speech recognition according to an embodiment of the present invention. In a search list, a user's favored music can be in a higher rank, and as a result, correct search results are enlisted in second and fourth ranks.

The invention can also be embodied as computer readable codes on a computer readable recording medium. The computer readable recording medium is any data storage device that can store data which can be thereafter read by a computer system. Examples of the computer readable recording medium include read-only memory (ROM), random-access memory (RAM), CD-ROMs, magnetic tapes, floppy disks, optical data storage devices, and carrier waves (such as data transmission through the Internet).

As described above, according to the present invention, by calculating search scores with respect to a speech input using an acoustic model, calculating preferences in music using a user preference model, reflecting the preferences in the search scores, and extracting a music list according to the search scores in which the preferences are reflected, a personal expression of a search result using speech recognition can be achieved, and an error or imperfection of a speech recognition result can be compensated for.

In addition, when music is searched using speech recognition, by showing a custom-made search result by reflecting a user preference, a user's favored music oriented result can be shown.

While this invention has been particularly shown and described with reference to preferred embodiments thereof, it will be understood by those skilled in the art that various changes in form and details may be made therein without departing from the spirit and scope of the invention as defined by the appended claims. The preferred embodiments should be considered in descriptive sense only and not for purposes of limitation. Therefore, the scope of the invention is defined not by the detailed description of the invention but by the appended claims, and all differences within the scope will be construed as being included in the present invention.

What is claimed is:

1. A method of searching music based on speech recognition, the method comprising:
(a) calculating search scores with respect to a speech input using an acoustic model;
(b) calculating preferences in music using a user preference model and reflecting the preferences in the search scores; and
(c) extracting a music list according to the search scores in which the preferences are reflected.

2. The method of claim 1, wherein (b) comprises calculating search scores in which the preferences are reflected by linearly combining the search scores and the preferences.

3. The method of claim 1, wherein (a) further comprises calculating grades for reflecting the preferences in the search scores using a world model in which quality of the input speech is modeled and stored.

4. The method of claim 3, wherein the world model is a Guassian Mixture Model (GMM) of the quality of the input speech.

5. The method of claim 1, wherein (a) further comprises calculating grades for reflecting the preferences in the search scores by calculating likelihoods of monophones of the acoustic model.

6. The method of claim 1, wherein (a) comprises calculating the search scores by normalizing the number of frames of the input speech.

7. The method of claim 1, wherein (b) comprises adjusting grades for reflecting the preferences in the search scores.

8. The method of claim 1, wherein (b) comprises calculating search scores on which the preferences are reflected using the equation
$$Score ( W ) = \frac{{max}_{w ∈ W} \{ log P ( x \vert {λ}_{w} ) \}}{{N}_{frame}} + {α}_{user} \cdot log P ( W \vert U ) ,$$
where N_{frame} denotes the length of an input speech feature vector, and αᵤₛₑᵣ denotes a constant indicating how much a music preference is reflected.

9. The method of claim 1, wherein (b) comprises calculating search scores on which the preferences are reflected using the equation
$$Score ( W ) = \frac{{max}_{w ∈ W} \{ log P ( x \vert {λ}_{w} ) \} - log P ( x \vert {λ}_{world} )}{{N}_{frame}} + {α}_{user} \cdot log P ( W \vert U ) ,$$
where N_{frame} denotes the length of an input speech feature vector, αᵤₛₑᵣ denotes a constant indicating how much a music preference is reflected, and λ_{world} denotes a world model used to remove an affection due to a change in speaking environment.

10. The method of claim 1, wherein (b) comprises calculating search scores in which the preferences are reflected using the equation
$$Score ( W ) = \frac{{max}_{w ∈ W} \{ log P ( x \vert λ ) \} - log P ( x \vert {λ}_{phone} )}{{N}_{frame}} + {α}_{user} \cdot log P ( W \vert U ) ,$$
where N_{frame} denotes the length of an input speech feature vector, αᵤₛₑᵣ denotes a constant indicating how much a music preference is reflected, and λₚₕₒₙₑ denotes an acoustic model formed with monophones to remove an affection due to a change in speaking environment.

11. A computer readable recording medium storing a computer readable program for executing the method of any one of claims 1 through 10.

12. An apparatus for searching music based on speech recognition, the apparatus comprising:
a user preference model modeling and storing a user's favored music; and
a search unit calculating search scores with respect to speech input using an acoustic model, calculating preferences in music using the user preference model, and extracting a music list by reflecting the preferences in the search scores.

13. The apparatus of claim 12, wherein the search unit comprises:
a search score calculator calculating search scores with respect to speech input using the acoustic model;
a preference calculator calculating preferences in music using the user preference model;
a synthesis calculator reflecting the preferences in the search scores; and
an extractor extracting a music list according to search scores in which the preferences are reflected.

14. The apparatus of claim 12, further comprising a world model in which quality of the input speech is modeled,
wherein the search unit further comprises a reflection calculator calculating reflection grades of the search scores using the world model.

15. The apparatus of claim 14, wherein the reflection calculator calculates grades for reflecting the preferences in the search scores by calculating likelihoods of monophones of the acoustic model.

16. The apparatus of claim 12, wherein the search unit calculates search scores on which the preferences are reflected using the equation
$$Score ( W ) = \frac{{max}_{w ∈ W} \{ log P ( x \vert {λ}_{w} ) \}}{{N}_{frame}} + {α}_{user} \cdot log P ( W \vert U ) ,$$
where N_{frame} denotes the length of an input speech feature vector, and αᵤₛₑᵣ denotes a constant indicating how much a music preference is reflected.

17. The apparatus of claim 12, wherein the search unit calculates search scores on which the preferences are reflected using the equation
$$Score ( W ) = \frac{\begin{matrix}{max}_{w ∈ W} \{ log P ( x \vert {λ}_{w} ) \} - \\ log P ( x \vert {λ}_{world} )\end{matrix}}{{N}_{frame}} + {α}_{user} \cdot log P ( W \vert U ) ,$$
where N_{frame} denotes the length of an input speech feature vector, αᵤₛₑᵣ denotes a constant indicating how much a music preference is reflected, and λ_{world} denotes a world model used to remove an affection due to a change in speaking environment.

18. The apparatus of claim 12, wherein the search unit calculates search scores in which the preferences are reflected using the equation
$$Score ( W ) = \frac{{max}_{w ∈ W} \{ log P ( x \vert {λ}_{w} ) \} - log P ( x \vert {λ}_{phone} )}{{N}_{frame}} + {α}_{user} \cdot log P ( W \vert U ) ,$$
where N_{frame} denotes the length of an input speech feature vector, αᵤₛₑᵣ denotes a constant indicating how much a music preference is reflected, and λₚₕₒₙₑ denotes an acoustic model formed with monophones to remove an affection due to a change in speaking environment.

19. An apparatus for searching music based on speech recognition, which comprises a feature extractor, a search unit, an acoustic model, a lexicon model, a language model, and a music database (DB), the apparatus comprising a user preference model modeling a user's favored music,
wherein the search unit calculates search scores with respect to a speech feature vector input from the feature extractor using the acoustic model, calculates preferences in music stored in the music DB using the user preference model, and extracts a music list matching the input speech by reflecting the preferences in the search scores.

20. The apparatus of claim 19, further comprising a world model in which quality of the input speech is modeled and stored,
wherein the search unit calculates reflection grades of the search scores using the world model.
